(19) United States
(12) Patent Application Publication
(10) Pub. No.: US 2004/0107441 A1
(43) Pub. Date: Jun. 3, 2004

(54) Satellite value added communication system and satellite value added communication control apparatus

(75) Inventor: Osamu Ichiyoshi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC TOSHIBA SPACE SYSTEMS, LTD.

(21) Appl. No.: 10/721,906

(22) Filed: Nov. 26, 2003

(30) Foreign Application Priority Data
Nov. 27, 2002 (JP) 344128/2002

(51) Int. Cl. H04N 7/173; H04N 7/20

(52) U.S. Cl. 725/63; 725/67; 725/109; 725/110

(57) ABSTRACT

A satellite value added communication system includes an information distribution center which connects to a satellite ground station and controls transmission/receiving of information to/from a satellite communication terminal. The information distribution center connects to the Internet based on a request from the terminal, and distributes predetermined contents to the terminal. The information distribution center connects to a variety of networks, and based on requests of users through the networks, distributes a large amount of information (contents) directly to user's terminals through a communication satellite. In this system, the information distribution center can control a conference or a seminar among the terminals.

### BACKGROUND OF THE INVENTION

1. Field of the Invention

The present invention relates to a satellite value added network, and particularly to a satellite value added communication system, in which a satellite communication terminal can easily utilize the Internet, and which is connectable to other satellite communication terminals and a ground communication network.

2. Description of the Related Art

A satellite value added network (hereinafter referred to as an SVAN), through which a user of a mobile satellite communication can access the Internet and utilize internet broadband, has received attention. The internet broadband is utilized for a bit stream communication such as internet broadcasting, a teleconference, and a seminar done by a large number of dispersed participants.

FIG. 1 shows a conventional satellite internet system. This system includes a communication satellite 1, the Internet 2, satellite internet terminals 3, a satellite earth station 4, an internet terminal 5, a satellite router 6, a satellite data center 7, and a contents provider 8 connecting to the Internet 2. The contents provider 8 includes, for example, an electronic library 81, a university/research institute 82, a broadcast station 83, and a large number of homepages (HP) 84. The satellite internet terminals 3 connect to the Internet 2 through the communication satellite 1, the satellite earth station 4 and the satellite router 6, and acquire desired contents from the contents provider 8. In this system, when a specific user starts to download a large file, a bandwidth for the other users is narrowed, and a transmission speed thereof is lowered more than that of a ground line. Accordingly, a business is performed, in which the satellite data center 7 collects popular contents and distributes the large amount of collected contents in a broadcasting format during a time period, for example at night, while lines are unoccupied (satellite data broadcasting system) is performed. The satellite internet terminals 3 receive, play back and store the large amount of data distributed thereto in a lump. Specifically, the satellite internet terminals 3 utilize necessary contents from the large amount of information stored therein. However, in this system, types of contents are limited. Moreover, an apparatus storing the information is large and expensive.

FIG. 2 shows a conventional contents delivery network (hereinafter referred to as a CDN). The CDN is a system which stores contents in a large number of cache servers arranged dispersedly and distributes the contents to a cache server closest to a user. This system includes local networks 11 such as a CATV network, a CATV router 12 for the Internet, edge routers 13, and cache servers 14. A data center 9 broadcasts the contents through the satellite earth station 4 and satellite lines to the cache servers 14 in respective areas. A user's CATV terminal 15, internet terminals 5 and a user's local terminal 16 utilize the stored contents through broadband lines in the respective areas, such as CATV and ADSL lines. However, this system requires ground networks such as the CATV and the ADSL.

Japanese Patent Laid-Open Publication No. 2001-94518 discloses a system in which an information center transmits value added information to wireless base stations through a communication satellite and the wireless stations provide the value added information to mobile terminals no matter whether or not the mobile terminals are under communication. Moreover, Japanese Patent Laid-Open Publication No. 2001-359030 discloses a system which makes a recording reservation for a broadcasting program from a portable terminal.

### SUMMARY OF THE INVENTION

An example of a satellite value added communication system of the present invention includes: a communication satellite; a satellite earth station which communicates with the communication satellite; a satellite communication terminal which transmits/receives information to/from the communication satellite; and an information distribution center which connects to the satellite earth station and controls transmission/receiving of the information to/from the satellite communication terminal. The information distribution center holds a list of the information to be transmitted to the satellite communication terminal and a transmission schedule of the information, and transmits the information to the satellite communication terminal in accordance with the transmission schedule. Moreover, an example of a satellite value added communication control apparatus of the present invention controls the transmission/receiving of the information to/from the satellite communication terminal. The apparatus includes: a server which holds information received through a ground network; a list of information to be transmitted to a satellite communication terminal and a transmission schedule of the information; a control unit which updates at least one of the list and the transmission schedule based on a request from the terminal; a transmission control circuit which controls the transmission of the information in the server in accordance with the transmission schedule; and a real time communication control unit which controls real time communication.

In the above-described system, a user acquires data freely from the Internet, and selected data is distributed to the user efficiently. In this system, information distribution systems are switched according to needs. Therefore, an appropriate traffic is maintained, and a large amount of information is supplied at low cost.

### BRIEF DESCRIPTION OF THE DRAWINGS

The above and other objects, features and advantages of the present invention will become apparent from the following detailed description when taken with the accompanying drawings in which:

FIG. 1 is a diagram showing an example of a conventional satellite communication system;

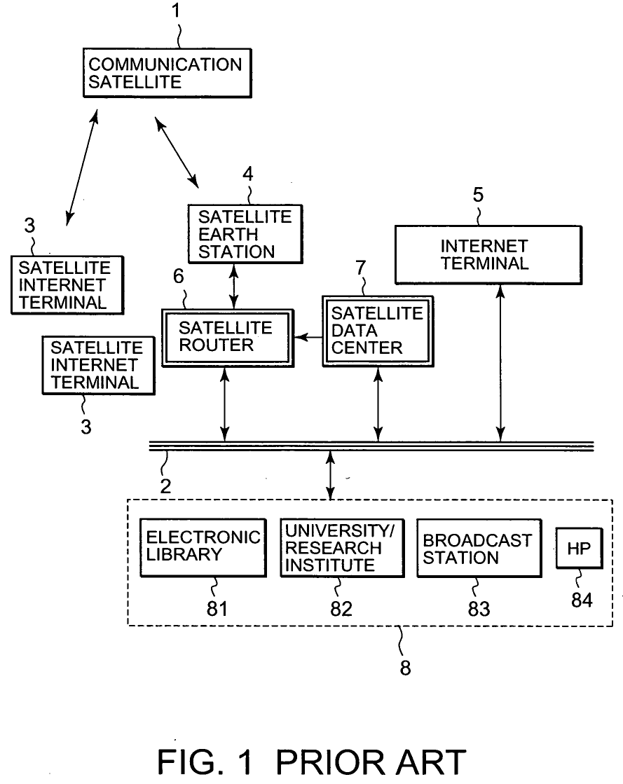

FIG. 2 is a diagram showing another example of the conventional satellite communication system;

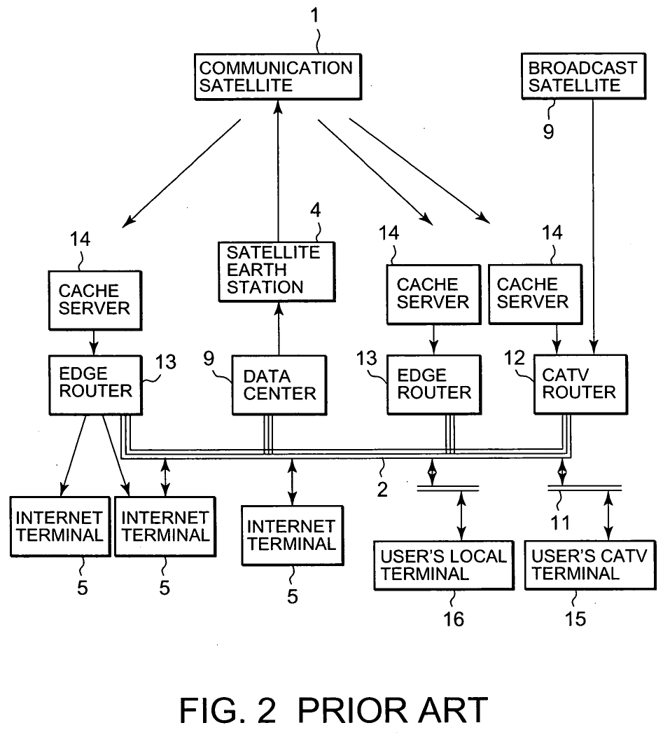

FIG. 3 is a block diagram showing an example of a satellite value added communication system of the present invention;

FIG. 4 is a block diagram showing an example of a user's SVAN terminal;

FIG. 5 is a block diagram showing an example of a satellite communication terminal;

FIG. 6 is a block diagram showing an example of an information distribution center;

FIG. 7 is a block diagram of another example of the satellite value added communication system;

FIG. 8 is a block diagram of still another example of the satellite value added communication system;

FIG. 9 is a diagram showing an embodiment of the satellite value added communication system; and

FIG. 10 is a diagram showing a function of the satellite value added communication system.

### DETAILED DESCRIPTION OF THE PREFERRED EMBODIMENTS

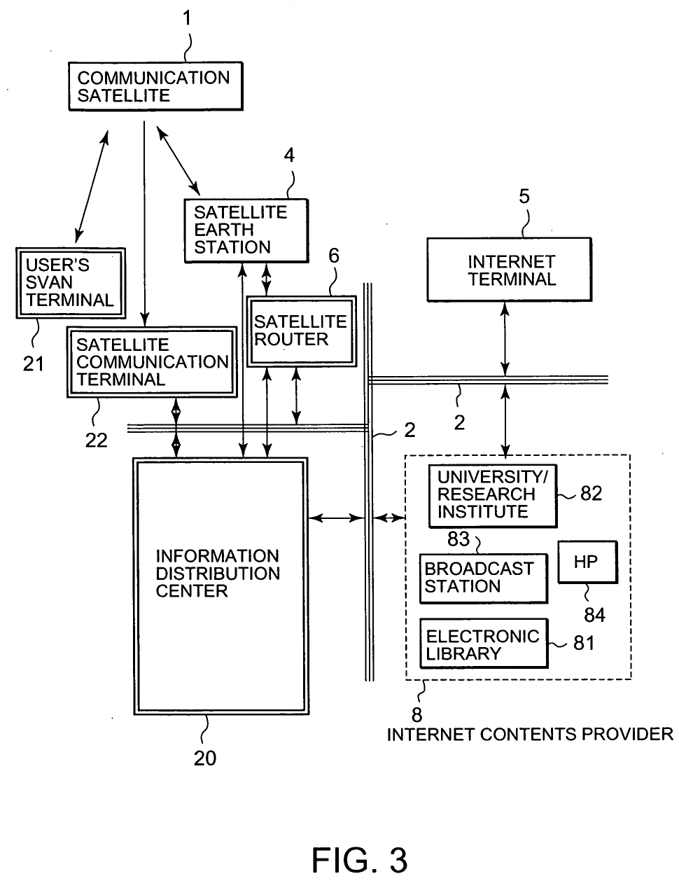

FIG. 3 shows an example of a satellite value added communication system of the present invention. This system includes a communication satellite 1, the Internet 2, a satellite earth station 4, a user's SVAN terminal 21, a satellite communication terminal 22, a user's internet terminal 5, a satellite router 6, an internet contents provider 8, and an information distribution center 20. The satellite earth station 4 and the user's SVAN terminal 21 having a duplex satellite access terminal (hereinafter referred to as a DXSAT) transmits/receives information with each other through the communication satellite 1. The satellite earth station 4 directly connects to the information distribution center 20. The satellite communication terminal 22 having a receive only satellite access terminal (hereinafter referred to as a ROSAT) receives information from the communication satellite 1, and transmits the information to the information distribution center 20 through the Internet 2. The satellite router 6 receives a control from the information distribution center 20, and transfers the information between the satellite earth station 4 and the Internet 2. The contents provider 8 includes a university/research institute 82, a broadcast station 83, an electronic library 81, a various types of homepages 84 and the like.

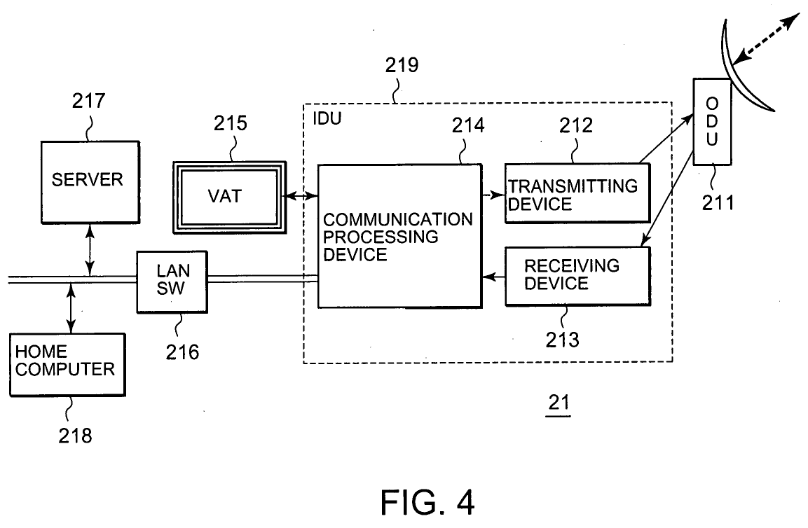

Referring to FIG. 4, an example of the user's SVAN terminal 21 provided with the DXSAT includes a pair of an antenna and an outdoor unit (ODU) 211, an indoor unit (IDU) 219, a value added terminal (hereinafter referred to as a VAT) 215, a LAN switch 216, a server 217, and a home computer 218. The IDU 219 has a transmitting device 212, a receiving device 213, and a communication processing device 214.

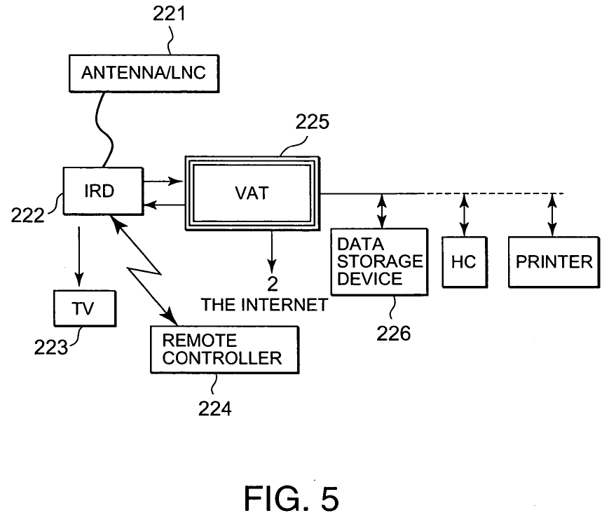

Referring to FIG. 5, an example of the satellite communication terminal includes an antenna/low noise converter (LNC) 221, an integrated receiver and decoder (hereinafter referred to as an IRD) 222, a TV 223, a remote controller 224, a VAT 225, a data storage device 226, a home computer (HC)230, and a printer 231. The satellite communication terminal transmits information to the information distribution center 20 through a ground network, and accordingly, the VAT 225 includes a function to connect to the Internet 2. The above-described VAT controls communications including a transmission of a signal to the information distribution center 20, a reservation of contents distribution from the information distribution center, and others.

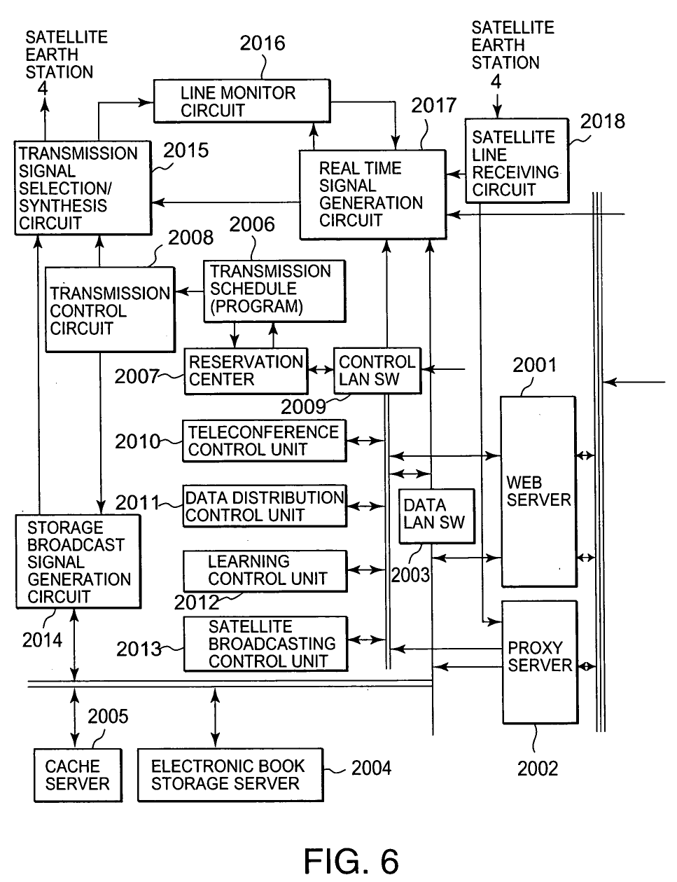

Referring to FIG. 6, an example of the information distribution center 20 includes: a web server 2001 and a proxy server 2002, which connect to the Internet 2; and a satellite line receiving circuit 2018 and a transmission signal selection/synthesis circuit 2015, which communicate with the satellite earth station 4. The information distribution center 20 further includes a data LAN including an electronic book storage server 2004, a cache server 2005 and a data LAN switch 2009, and includes a control LAN including respective control units 2010 to 2013, and a control LAN switch 2009. The control units 2010 to 2013 control various types of services provided by the satellite value added communication system. For example, there are listed the teleconference control unit 2010, a data distribution control unit 2011, a learning control unit 2012, a satellite broadcasting control unit 2013 and the like. One control device can include all the functions of these control units. The information distribution center 20 further includes a transmission schedule 2006, a reservation center 2007, a transmission control circuit 2008, a storage broadcast signal generation circuit 2014, a line monitor circuit 2016, and a real time signal generation circuit 2017. Contents obtained from the Internet 2 are stored in the electronic book storage server 2004 and the cache server 2005 through the data LAN switch 2009. The electronic book storage server 2004 stores unchanged data such as an electronic book. The cache server 2005 stores quickly changed data such as news. The reservation center 2007 manages the transmission schedule 2006 that is a list of the information to be transmitted by the information distribution center. A user can access the reservation center 2007, read out the transmission schedule 2006, and get to know a transmission schedule of a program. Alternatively, in order to hold a teleconference or a seminar, a user can reserve an unoccupied time period (a time period when an information transmission is not scheduled), notify the time period to terminals of conference participants through the satellite or ground network, and make the reservations on the terminals. When a user requests the data distribution, the reservation center 2007 reserves a line, and stores, in the cache server 2005, data acquired from the Internet 2 through the web server 2001. The transmission control circuit 2008 controls a transmission operation of the data to the satellite line. At a predetermined point of time, the transmission schedule 2006 outputs a transmission signal generation instruction to the transmission control circuit 2008. When the instruction is to distribute previously-stored contents, the transmission control circuit 2008 controls the storage broadcast signal generation circuit 2014. The storage broadcast signal generation circuit 2014 reads out designated contents from the electronic book storage server 2004 or the cache server 2005, generates a transmission signal, and transmits the transmission signal to the satellite earth station 4 through the transmission signal selection/synthesis circuit 2015. In the case of a real time communication such as in a normal use of a satellite internet, a teleconference and a seminar, and internet live broadcasting, the real time signal generation circuit 2017 synthesizes information received from the Internet or information received by the communication satellite through the satellite line receiving circuit 2018. For example, in the case of a teleconference, the real time signal generation circuit 2017 synthesizes a control signal to be transmitted through the control LAN switch 2009 from the teleconference control unit 2010 which controls a right to speak, a temporary change of a code and the like. An output of the real time signal generation circuit 2017 is selected/synthesized in the transmission signal selection/synthesis circuit 2015, and transmitted to the communication satellite through the satellite earth station 4.

An operation example of the satellite value added communication system is described below. The broadcast station 83 makes a request to the information distribution center 20 for broadcasting. The information distribution center 20 stores contents acquired from the broadcast station 83 through the Internet 2, and updates the transmission schedule. The user's SVAN terminal 21 and the satellite communication terminal 22 connect to the information distribution center, read out the transmission schedule, and make reservations on themselves. At a scheduled point of time, the information distribution center 20 distributes (broadcasts) the stored contents to the user's SVAN terminal 21 and the satellite communication terminal 22.

The educational and research institute 82 such as a university, the electronic library 81, or the HP 84 makes a request for a distribution reservation to the information distribution center 20. The information distribution center 20 updates the schedule, and informs the user's SVAN terminal 21 and the satellite communication terminal 22 of the transmission schedule according to needs. At a predetermined point of time, the information distribution center 20 performs live broadcasting of a seminar, an exhibition or the like for the user's SVAN terminal 21 and the satellite communication terminal 22.

With regard to distribution of the contents, the user's SVAN terminal 21 and the satellite communication terminal 22 first request a data list to the information distribution center 20. The information distribution center 20 submits the data list to the user's SVAN terminal 21 and the satellite communication terminal 22. The user's SVAN terminal 21 and the satellite communication terminal 22 request desired contents to the information distribution center 20. The information distribution center 20 searches the transmission schedule. When the distribution of these contents is scheduled, the information distribution center 20 notifies the distribution schedule to the user's SVAN terminal 21 and the satellite communication terminal 22. When the distribution of these contents is not scheduled, the information distribution center 20 updates the transmission schedule, and notifies the updated transmission schedule to the user's SVAN terminal 21 and the satellite communication terminal 22. Upon receiving a notice of the transmission schedule, the user's SVAN terminal 21 and the satellite communication terminal 22 make the reservations for themselves. At a point of time when the transmission is scheduled, the information distribution center 20 broadcasts the contents to the respective terminals described above. The information distribution center 20 transmits the contents to the communication satellite 1 through the satellite earth station 4, and the communication satellite 1 directly transmits the contents to the user's SVAN terminal 21 and the satellite communication terminal 22 directly. Data communication between the contents provider 8 and the user's SVAN and satellite communication terminals 21 and 22 is performed through the communication satellite 1, the satellite earth station 4, and the satellite router 6 for the information distribution center 20.

The above-described direct satellite contents delivery network (DS-CDN) will be described in far more detail. In order to utilize the satellite line efficiently, it is necessary to distribute only contents selected by a user. The user receives and stores only the contents requested by him/herself, and accordingly, the user can utilize a compact terminal, and an expense for the above is also reduced. (1) The user connects to the information distribution center 20 through the Internet 2 and the web server 2001 or through the satellite line and the satellite line receiving circuit 2018. Moreover, the user connects to the data distribution control unit 2011 through the control LAN switch 2009, reads out a directory of the data stored in the electronic book storage server 2004 and the cache server 2005, thus making it possible to retrieve desired contents. (2) When finding the desired contents, the user performs a purchase procedure of the contents. The purchase procedure is executed by electronic commerce between the data distribution control unit 2011 and the user through the ground network or the satellite line. (3) Next, the data distribution control unit 2011 investigates the distribution (transmission) schedule 2006. When the designated contents are already present in the distribution schedule 2006, the data distribution control unit 2011 notifies a date of the distribution to the user. When the contents are not present in the distribution schedule 2006, the data distribution control unit 2011 notifies this matter to the user. The user can designate a delivery time. The data distribution control unit 2011 controls the reservation center 2007, makes the distribution reservation within the delivery time designated by the user, and updates the distribution schedule 2006. Simultaneously, the information distribution center 20 performs an operation of making the reservations for the user's terminal through the ground network or the satellite communication. The VATs 215 and 225 of the terminals 21 and 22 communicate with the data distribution control unit 2011, thus making the reservations. The contents of the reservations are a distribution time, a distribution channel (a wireless frequency, a packet identifier), a key to decode a code, and the like. (4) When the scheduled time of the contents distribution approaches, based on the instruction of the transmission control circuit 2008, the storage broadcast signal generation circuit 2014 reads out the designated contents from the electronic book storage server 2004 or the cache server 2005, generates the transmission signal, and sends the generated transmission signal to the transmission signal selection/synthesis circuit 2015. The VATs 215 and 225 turn on a power supply a little before the scheduled time of the distribution to start receiving preparation, and start to receive the designated channel. The terminals 21 and 22 receive designated packets and correct errors thereof. To the information distribution center 20, the terminals 21 and 22 transmit retransmission requests of packets from which the errors have been detected. The transmission signal selection/synthesis circuit 2015 of the information distribution center 20 accepts retransmission request signals for a fixed time, for example, 10 seconds, and again, broadcasts only the packets for which the retransmission requests have been made. Thereafter, the same operation is repeated until the retransmission requests disappear or until the set fixed time elapses. If the errors do not disappear completely, the distribution is performed again at the next reserved distribution.

Next, a procedure of the teleconference or seminar where a large number of dispersed participants attend will be described below. (1) An organizer of the conference connects to the information distribution center 20 through the ground network or the satellite line. The organizer connects to the teleconference control unit 2010, transmits information such as a preferred date of the conference, a necessary bandwidth, a participant (terminal) list, and as to whether or not the conference is laid open, and requests the reservations. Based on such information, the teleconference control unit 2010 scans the distribution schedule 2006 through the reservation center 2007, finds an unoccupied time period that is the most suitable for the conditions, and sends the time period as an answer to the organizer. If the organizer accepts the time, the transmission schedule 2006 is updated. In addition, a procedure such as a payment of a fee is performed by electronic commerce. (2) The information distribution center accesses the terminals of the participants, and makes the reservations therein. (3) At the reserved time, the organizer (terminal) connects to the information distribution center 20 through the ground network or the satellite line, and starts the conference. Signals for use in the conference include a speech signal and a control signal. The speech signal is transmitted to the satellite line through the real time signal generation circuit 2017. The control signal is processed in the teleconference control unit 2010, and an output thereof is multiplexed with other signals in the real time signal generation circuit 2017 and transmitted to the satellite line. The control signal controls the right to speak and controls an emergency change of the code. The right to speak is managed by a chairperson. The teleconference control unit 2010 sends a speech request signal from a participant to the chairperson, and as described above, sends a speech permission signal designated by the chairperson to the satellite line in a multiplexing manner. The participant presses are quest button when requesting to speak, and when the right to speak is given thereto, the participant confirms a display showing that the right is given, and sends the speech signal to the information distribution center 20. The real time signal generation circuit 2017 confirms that the sent speech signal is a signal of a speaker coinciding with the permission signal from the teleconference control unit 2010, and distributes the speech signal to the satellite line. When viewed from the participant, this system is a Press and See Green to Talk system. The participant executes “Press,” and sends the speech request to the system. When the right to speak is given to the participant, a green indicator of a participant's terminal lights up, and it is made possible for the participant to speak. Moreover, a teleconference without a chairperson visible to the participants is enabled. In this case, an automatic hosting apparatus in the teleconference control unit 2010 can be utilized. For the operation, such a speech time limiting method as one for use in a multi channel access (MCA) can be utilized. When the reserved time elapses, the conference terminates automatically. When the conference terminates before the reserved time elapses, the teleconference control unit 2010 performs termination processing based on an instruction of the chairperson. If there is a residual time of a certain level or more, information indicating this matter is notified to the transmission signal selection/synthesis circuit 2015, and it is made possible to utilize the satellite line effectively.

The above-described two operating functions enable a variety of operations. For example, one realized by such an operation is a learning at home system. The learning control unit 2012 includes a variety of learning courses, and can provide a function for communications between teachers and students, a function to broadcast the next seminar, a function to allow questions and reports to be submitted, a function of a bulletin board, and the like. The data distribution control unit 2011 can control distribution of learning material. The teleconference control unit 2010 enables the seminar to be executed. A direct operation for small office/home office (SOHO) via satellite is also possible.

The provider of the internet broadcasting can reserve the satellite line and can perform the broadcasting by use of the satellite line. Moreover, as for the satellite internet, a plurality of users connect to the Internet by use of an always-on connection and one satellite line as an access line. The users connect to the information distribution center 20 through the ground network or the satellite line. The information distribution center 20 connects to the Internet 2 through the proxy server 2002. Data taken from the Internet 2 is transmitted to the satellite line through the data LAN switch 2003 and the real time signal generation circuit 2017. By the control of the VATs 215 and 225, the users can utilize the contents to be displayed on the PC 230 or the TV 223. When a specific user downloads a large file, a capacity of the satellite line becomes insufficient, and a communication capacity for the other users becomes insufficient. Moreover, if a large number of users use the satellite line independently of one another, the retransmission requests are radically increased, causing a possibility that the line is unstabilized. In the present invention, the proxy server 2002 monitors the sizes of the contents. When detecting data of a certain size or more, for example, data of 10 MB or more, the proxy server 2002 instructs the data distribution control unit 2011 to activate and perform a reserved distribution operation for the data, thus making it possible to put a lower priority thereto in the reserved distribution. Moreover, the proxy server 2002 notifies this matter to the user. By theses operations, congestions in the satellite line are avoided.

The transmission signal selection/synthesis circuit 2015 of the information distribution center 20 constantly monitors capacity of the satellite line in use. When the capacity of the satellite line in use exceeds a predetermined level, the line monitor circuit 2016 transmits an alert signal to the real time signal generation circuit 2017, generates transmission control signals for the user's terminals, and transmits the generated signals to the real time signal generation circuit 2017. These operations can control the use of the user's terminals. For example, a specific group is prohibited temporarily from communications, and unstabilization of the line is prevented. Moreover, if there is an unoccupied line in a communication using a line of a 64 kbps band, the transmission signal selection/synthesis circuit 2015 can permit a transmission at the above-described speed or more. For example, in a teleseminar of music, a voice of a teacher can be transmitted at 64 kbps, and music can be transmitted at 128 kbps.

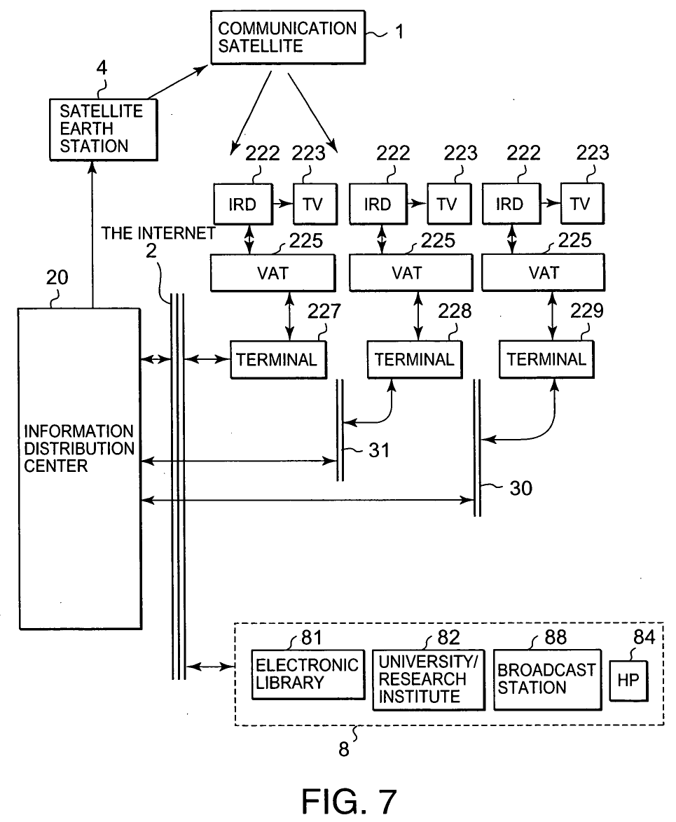

Referring to FIG. 7, another example of the satellite value added communication system is shown. An information distribution center 20 connects to a mobile network 31 and a public switched telephone network (PSTN) 30 as well as the Internet 2. Each of terminals 227, 228 and 229 connecting to these ground networks includes a VAT 225, an IRD 222, and a TV 223. In this system, the respective terminals described above transmit signals to the information distribution center 20 through the variety of ground networks, and receive contents and the like from the information distribution center 20 through a communication satellite 1. A cellular phone can be utilized as the terminal 228 connecting to the mobile network 31.

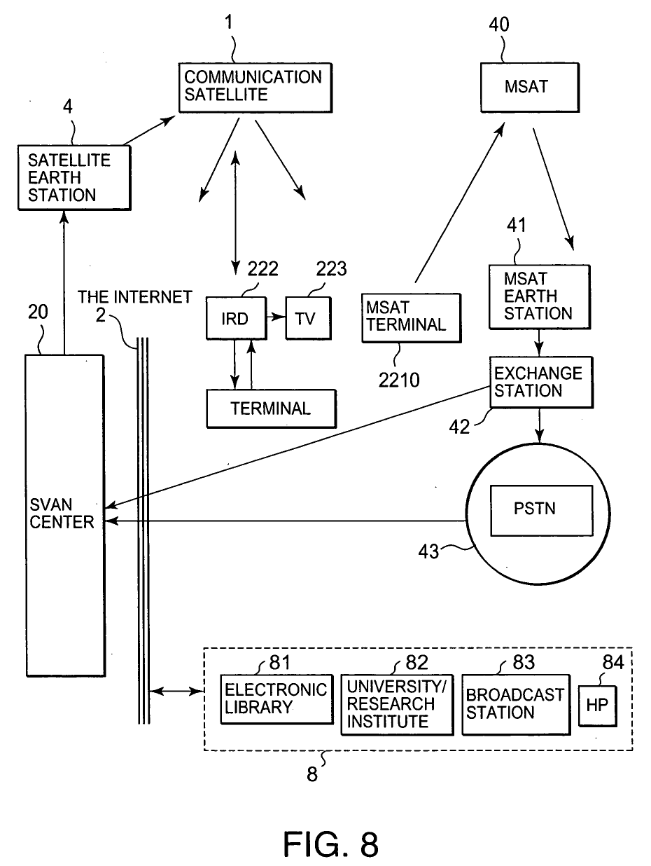

Referring to FIG. 8, still another example of the satellite value added communication system is shown. An information distribution center 20 connects to another mobile satellite communication system. This mobile satellite communication system includes a mobile satellite (MSAT) 40 for mobile communications, an MSAT earth station 41, an exchange station 42, and an MSAT terminal 2210. The MSAT terminal 2210 can access the information distribution center 20 through the MSAT 40, the MSAT earth station 41 and the exchange station 42, and can receive a variety of contents distributed through the information distribution center 20. Terminals of different satellite communication systems can perform communications or hold a teleconference. As examples of the mobile satellites for mobile communications, there are Inmarsat, Thuraya, ACeS, AMSC/TMI and the like.

In the satellite value added communication system of the present invention, the traffic for use in the reservations is small, and accordingly, the terminals connecting to the various networks described above can make the reservations. Meanwhile, the broadcasting of the reserved contents is executed by the broadband satellite network. A direct satellite broadcasting network involving a large number of subscribers can be utilized for the present invention.

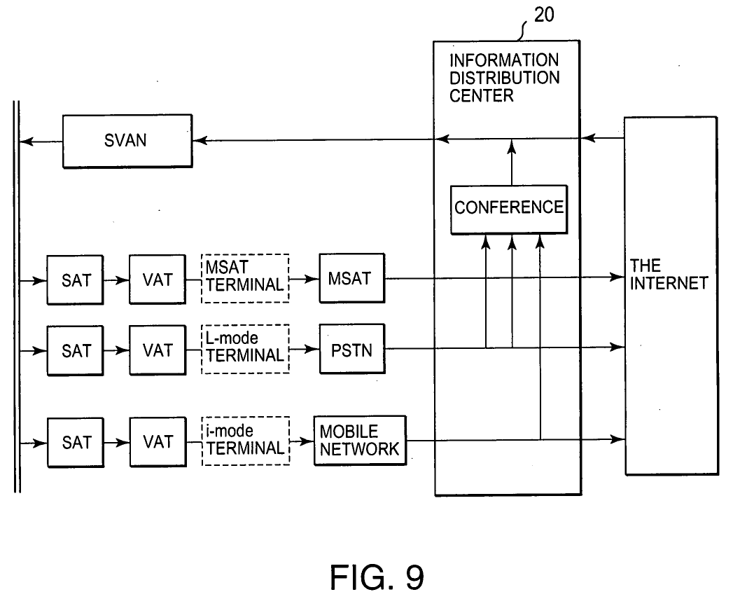

Referring to FIG. 9, as a utilization example of the satellite value added communication system of the present invention, an example of a teleconference and contents distribution is shown. Individual users of a mobile satellite (MSAT) network, a PSTN (L-mode) and a mobile network (i-mode) send request signals to an information distribution center 20. The information distribution center 20 in place of the users connects to the Internet 2, and distributes requested contents and the like to the users through a satellite value added network (SVAN). Through satellite access terminals (SATs) and value added terminals (VATs), the users receive the contents distributed from a communication satellite. The users can acquire contents from the Internet that cannot be utilized if usual. In the case of a teleconference, the users transmit speech contents of their own and speech request signals to the information distribution center through the respective networks. The information distribution center 20 distributes the speech contents of the participants (users) through the satellite value added network (SVAN) by utilizing a broadcasting line. Thus, users of a variety of networks which have never been mutually connected heretofore can attend the same teleconference.

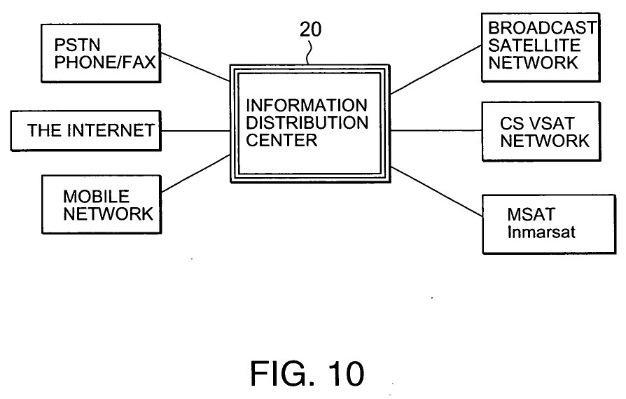

As shown in FIG. 10, the SVAN of the present invention interconnects many networks such as a satellite broadcasting network, satellite communication network, a mobile satellite network, a PSTN, the Internet, and a ground mobile network. In the satellite value added communication system of the present invention, subscribers of networks, who cannot utilize the Internet, can receive a large amount of information from the communication satellite by utilizing direct satellite broadcasting (DSB) terminals. Moreover, the subscribers can receive broadband contents such as internet broadcasting easily through the SVAN. Furthermore, it is possible to hold a teleconference easily among the subscribers.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A satellite value added communication system, comprising:
a communication satellite;
a satellite earth station which communicates with the communication satellite;
a satellite communication terminal which transmits/receives information to/from the communication satellite; and
an information distribution center which connects to the satellite earth station and controls transmission/receiving of the information to/from the satellite communication terminal,
wherein the information distribution center holds a list of the information to be transmitted to the satellite communication terminal and a transmission schedule of the information, and transmits the information to the satellite communication terminal in accordance with the transmission schedule.

2. The satellite value added communication system according to claim 1,
wherein the information distribution center updates the list of the information and the transmission schedule of the information.

3. The satellite value added communication system according to claim 1,
wherein the information distribution center notifies at least one of the list of the information and the transmission schedule of the information to the satellite communication terminal.

4. The satellite value added communication system according to claim 1,
wherein the information to be transmitted to the satellite communication terminal is information which the information distribution center has received through a ground network.

5. The satellite value added communication system according to claim 4,
wherein the information distribution center saves the information.

6. The satellite value added communication system according to claim 1,
wherein the information distribution center controls communications among a plurality of predetermined terminals which connect thereto.

7. The satellite value added communication system according to claim 6,
wherein the information distribution center specifies the plurality of predetermined terminals based on requests therefrom, and sends advance notices to the plurality of terminals prior to information transmission.

8. The satellite value added communication system according to claim 6,
wherein the terminals include a terminal which connects to a ground network, and the satellite communication terminal.

9. The satellite value added communication system according to claim 1,
wherein the information distribution center connects to a ground network based on a request from the satellite communication terminal, and transmits, to the satellite communication terminal, information to be provided by an information provider.

10. The satellite value added communication system according to claim 1,
wherein the information distribution center connects to a ground network, and controls the transmission/receiving of the information to/from a communication terminal which connects to the ground network.

11. The satellite value added communication system according to claim 1,
wherein the satellite communication terminal includes a device which controls the transmission/receiving of the information to/from the information distribution center.

12. The satellite value added communication system according to claim 1, further comprising a communication terminal which receives the information from the communication satellite and transmits a signal to the information distribution center through a ground network.

13. The satellite value added communication system according to claim 10,
wherein the ground network includes at least one of the Internet, a mobile network and a public switched telephone network.

14. The satellite value added communication system according to claim 1,
wherein the information distribution center connects to another satellite communication system, and controls the transmission/receiving of the information to/from a satellite communication terminal of the another satellite communication system.

15. A satellite value added communication control apparatus that controls distribution of information to a satellite communication terminal, the apparatus comprising:
a server which holds information received through a ground network;
a list of information to be transmitted to the satellite communication terminal and a transmission schedule of the information;
a control unit that updates at least one of the list and the transmission schedule;
a transmission control circuit that controls the transmission of the information in the server in accordance with the transmission schedule; and
a real time communication control unit that controls a real time communication.

16. The satellite value added communication control apparatus according to claim 15,
wherein the control apparatus connects to the ground network, and controls transmission/receiving of the information between a communication terminal that connects to the ground terminal and a satellite communication terminal.

17. The satellite value added communication control apparatus according to claim 15, further comprising means for monitoring usage of a line to a satellite earth station and controlling usage of the line.

18. The satellite value added communication control apparatus according to claim 15, further comprising means for monitoring an amount of information received from the ground network and controlling transmission of the information to a terminal.

19. The satellite value added communication control apparatus according to claim 18,
wherein the means delays the transmission of the information to the terminal for a predetermined period of time when the amount of information received from the ground network is a predetermined amount or more.

20. The satellite value added communication control apparatus according to claim 15,
wherein the control apparatus is included in a satellite communication system, connects to another satellite communication system, and controls transmission/receiving of the information to/from the another satellite communication system.

21. The satellite value added communication control apparatus according to claim 15, further comprising means for connecting to the Internet based on a request from a terminal and transmitting, to the terminal, information to be provided by an information provider.

22. The satellite value added communication control apparatus according to claim 15,
wherein the control unit transmits the transmission schedule of the information to a terminal.

23. The satellite value added communication control apparatus according to claim 15, further comprising a conference control unit that controls a conference among a plurality of satellite communication terminals.

24. The satellite value added communication control apparatus according to claim 23,
wherein the conference control unit controls a conference among a plurality of communication terminals that connect to the ground network and the satellite communication terminals.
